(19) United States
(12) Patent Application Publication
(10) Pub. No.: US 2014/0272315 A1
(43) Pub. Date: Sep. 18, 2014

(54) METHOD FOR FABRICATING NEGATIVE PHOTORESIST ETCHED PITS AND TRENCHES AS CONTROLLED OPTICAL PATH AND A DEVICE FABRICATED THEREBY

(71) Applicant: TYCO ELECTRONICS CORPORATION, Berwyn, PA (US)

(72) Inventors: Jonathan Edward LEE, Harrisburg, PA (US); Mike Tryson, Hanover, PA (US)

(73) Assignee: Tyco Electronics Corporation, Berwyn, PA (US)

(21) Appl. No.: 13/841,555

(22) Filed: Mar. 15, 2013

(51) Int. Cl. G02B 7/00

(52) U.S. Cl. CPC G02B 7/003
USPC 428/172; 427/162; 216/24

(57) ABSTRACT

This invention overcomes the challenge of finding and applying a suitable underfill material in an optical engine by filling the gap between a substrate-mounted optical device (such as a VCSEL/PIN) and a fiber transmitting light to/receiving light from the optical device. The air gap is filled with SU-8 Negative Photoresist (or any material with the same functional and optical characteristics) via spin coating during the wafer processing portion of the engine assembly. The SU-8 material can be used to fill only the area around a 45 degree mirror (i.e., the pit) or can be deployed both in the pit and part of the fiber trench.

### BACKGROUND OF THE INVENTION

1. Field of the Invention

The present invention relates to semiconductor optical devices, and more specifically relates to a novel process for fabricating an optical device in which a negative photoresist is deposited in etched pits and trenches to serve as a controlled optical path, and novel devices fabricated according to the process.

2. Description of the Related Art

Optical fiber communications technology has grown rapidly over the past several years due to the ever increasing need for bandwidth, and considerable effort has been spent on developing low cost optical packages. Packaging is a high cost element of producing fiber optic devices because of the difficulties associated with coupling laser light into and out of a fiber optic cable. Alignment tolerances of a fiber to a laser diode or optical receiver are on the order of microns (10⁻⁶ meter), and the alignment process is slow, labor intensive, and difficult to automate. Additionally, the separation distance between the fiber and the laser/receiver should be as short as possible to reduce beam divergence and maximize coupling. As a result, the cost of packaging fiber optic devices is high.

Recently, optical engines have been developed to reduce device size and packaging costs. An optical engine is a platform that combines active optical elements (i.e. lasers and receivers) and passive fiber optic cables. The engine substrate can be made of any material (typically silicon or glass) that exists in wafer form and that can be processed using commonplace semiconductor manufacturing techniques. Hundreds of engine substrates are processed simultaneously on a wafer of material, e.g., silicon or glass, before they are separated into individual elements. Once separated, active optical elements are mounted onto the substrate and fiber optic cables are aligned. Trenches or grooves cut into the substrate during processing aid in aligning the fibers to their respective lasers/receivers.

FIG. 1 illustrates the cross-section of a typical engine substrate 10 with an optical fiber 12 situated thereon. In actual practice an active optical element, e.g., a vertical-cavity surface emitting laser (VCSEL) (or PIN photodiode) (not shown) could be situated atop the substrate facing downward to receive light transmitted from or to transmit light to the optical fiber. The path of light propagation is illustrated by the arrows. In FIG. 1, a mirror-like surface along the edge 14 of the substrate 10 is required to turn the light to/from the fiber (although in FIG. 1, edge 14 appears to be a “layer”, it is in fact just an edge and is shown in this manner in FIG. 1 to make it simpler to see the edge 14). In the prior art, the edge 14 of the substrate 10 must be highly polished in order to obtain the mirror finish along the edge 14. This polishing process can be time-consuming, difficult, and costly.

If nothing more is added to the configuration shown above, an air gap would exist between the optical fiber 12 and the edge 14. The air gap can lead to coupling loss due to the refractive index mismatch between the air (n=1.00) and the fiber (n=1.465). In the prior art, this gap is typically filled with a higher index material (n>1), resulting in less beam divergence and higher coupling. For example, in some devices a VCSEL/PIN device might be flip-chip mounted to the substrate 10, and its output reflected by the 45 degree “mirror” formed by the polished edge 14 before it is coupled into optical fiber 12. The pit in which the 45 degree mirror sits and the trench which holds the optical fiber 12 are both fabricated via dry etching during the substrate processing phase. Given the layout and the sub-millimeter geometries of such a module, a viscous material such as an epoxy/adhesive optical underfill, illustrated by shaded portion 16, is typically used to fill the gap between the VCSEL/PIN and the optical fiber 12. However, the underfill must meet a wide variety of mechanical criteria to be dispensed and cured properly, and optical criteria must be met to maximize coupling. When the underfill is flowed into the air gap, air bubbles and other discontinuities can form in the underfill as it cures. These discontinuities are detrimental to the coupling between the active element and the optical fiber 12.

### SUMMARY OF THE INVENTION

This invention overcomes the challenge of finding and applying a suitable underfill material by filling the gap between a substrate-mounted optical device (such as a VCSEL/PIN) and a fiber transmitting light to/receiving light from the optical device. According to the claimed invention, the air gap is filled with SU-8 Negative Photoresist (or any material with the same functional and optical characteristics) via spin coating during the wafer processing portion of the engine assembly. In the examples described below, the wafer is silicon; however, it is understood that the wafer can be glass or any other wafer material that can be processed using semiconductor fabrication techniques. The SU-8 material can be used to fill only the area around the 45 degree mirror (i.e., the pit) or can be deployed both in the pit and part of the fiber trench. The approaches are detailed in the attached descriptions and diagrams.

A benefit of filling the gap this way is that a metal layer can be deposited along the “mirror edge” during the deposition process, and left in place in the appropriate locations after the etching process so that the metal layer serves as the mirror service and negates the need to polish the substrate edge to a mirror finish as is done in the prior art.

An additional advantage of the claimed invention is that in a structure such as that shown in the examples herein, in which a bare fiber end is inserted into the trench and there is no diffractive element to control the light as it exits the fiber, the fill material (in this example, the SU-8) is selected to have a refractive index that is closely matched to that of the fiber, thereby preventing or limiting the divergence of the light beam after it leaves the fiber.

This process enables the ability to control fine geometries of the optical path material and monitor the quality of the optical path (dimensions, void free, alignment to mechanical features in the silicon substrate fabrications, etc.) and avoid the polishing process for the mirror surface.

### BRIEF DESCRIPTION OF THE DRAWINGS

FIG. 1 illustrates the cross-section of a typical engine substrate with an optical fiber situated thereon;

FIGS. 2-13 illustrate a first embodiment in which the pit portion of the engine substrate is filled according to the claimed invention; and

FIGS. 14-20 describe a second embodiment, in which both the pit and trench portions of the engine substrate are filled with the negative photoresist.

### DETAILED DESCRIPTION OF THE PREFERRED EMBODIMENTS

FIGS. 2-13 illustrate a first embodiment in which the pit portion of the engine substrate is filled according to the claimed invention. Referring to FIG. 2, the substrate 210 is a single element fashioned from a wafer of material that has been processed using semiconductor fabrication techniques. The wafer material is typically silicon or glass (e.g., borosilicate glass or pyrex) but can be any material which can be patterned using photoresist/etching processes to form the element described below. Using an anisotropic etching process, such as reactive ion etching, a 45 degree “pit” 213 is etched into the substrate 210 surface as shown, forming edges 214 thereon. The angled portions of edges 214 may also be referred to as “mirror faces”, although in accordance with the claimed invention, they do not become mirrored until later in the process as described further below. It is understood that a 45 degree pit is used for the purpose of example and that the claimed invention is not limited to a pit having angles of 45 degrees.

As shown in FIG. 3, a thin layer of silicon dioxide (SiO₂) 220 (of sufficient thickness to protect the substrate, e.g., 50 nm) is grown or deposited on the entire exposed upper surface of the substrate 210, including onto the exposed portions of pit 213, using known growing/depositing techniques. This layer serves as a mask layer during the metal deposition described below. As can be seen in FIG. 4, a sacrificial layer 222 of positive photoresistive material (e.g., Shipley 220) is then spin-coated onto the surface of the substrate 210 using known spin-coating techniques. Next, as shown in FIG. 5, the now-coated optical bench 210 is exposed to UV light 230 such that an isolated portion of the sacrificial layer 222 located adjacent to the left side of the pit 213 (in this example) is exposed to the UV light while the remainder is masked from the UV light. The exposed portion of the sacrificial layer 222 becomes soluble to a photoresist developer after exposure while the remainder of the sacrificial layer remains insoluble to the photoresist developer. As shown in FIG. 6, when the substrate 210 is exposed to a photoresist developer, e.g. MF-319, the portion of the sacrificial layer 222 exposed to the UV light is removed by the developer.

As shown in FIG. 7, a layer of metal 224 is deposited on the entire exposed upper surface of the optical bench 210 via sputtering, chemical vapor deposition, or any other commonly used method. Examples of metals that can be used during this depositing process include gold and aluminum, although any metal that is highly reflective at the laser wavelength can be used. It is this metal, which is deposited along edge 214 of the pit 213, that forms the mirror face that will eventually direct light propagation to/from and optical fiber at a 45 degree angle (in this example).

Next, as shown in FIG. 8, a layer 226 of negative photoresist is applied to the substrate 210 via spin-coating. In a preferred embodiment, the negative photoresist is SU-8 photoresist. Since SU-8 is an epoxy-based negative photoresist, it provides good mechanical stability. As can be seen, this application covers the substrate and fills in the pit 213, and thus covers the metal layer 224.

As can be seen in FIG. 9, in this example the substrate covered with the layer 226 of negative photoresist is subjected to an etching process, in a known manner, to remove the unwanted negative photoresist. Either a wet or dry etching process can be sued for this etching step. The negative photoresist should be etched down to a point where an active optical element mounted on top of the substrate will not contact the remaining negative resist. In FIGS. 9-13, the remaining negative photoresist 226 is slightly higher than the substrate 210 surface. The exact etch depth may be deeper or shallower depending on the specified application. Next, as shown in FIG. 10, the substrate is exposed to UV light 230 through the same mask from the first exposure process. Since the photoresist being exposed is a negative photoresist, the negative photoresist 226 (in this example, the SU-8) will solidify in the pit 213. In FIG. 11, a chemical resist stripper is used to remove the remainder of the sacrificial positive resist layer 222 along with the unwanted metal layer 224.

As shown in FIG. 12, the substrate 210 is stripped of the remaining SiO₂ layer 220, and then, using an anisotropic etch, a fiber trench 228 is etched into optical bench. Finally, as shown in FIG. 13, the optical fiber 212 is installed. As can be seen, the remaining negative photoresist 226 fills the air gap created by the pit 213, and the remaining metal layer 224 on the left 45 degree angle of the pit provides the mirror face needed to direct the light to/from the optical fiber 212.

FIGS. 14-20 describe a second embodiment, in which both the pit and trench portions of the engine substrate are filled with the negative photoresist. This embodiment uses similar techniques, but requires fewer, albeit slightly different, steps. Referring to FIG. 14, the process begins by etching the pit 313 and trench 315 into the engine substrate 310. This is accomplished using an anisotropic etching technique, as described above in connection with the first embodiment.

As shown in FIG. 15, a metal layer 324 is deposited on all surfaces of the substrate 310 except for any vertically-oriented surfaces. The same metals and techniques as described above in connection with the first embodiment can be used. Next, as illustrated in FIG. 16, the entire surface of the substrate 310 is coated with an negative photoresist 326 such as SU-8, using known coating techniques such as spin coating. Since the trench 315 is deeper than the pit 213 of the first embodiment, multiple coatings of the negative photoresist 326 may be required.

To etch the surface of the negative photoresist 326 down to a desired thickness (i.e., to a depth where the trench 315 and pit 313 remain filled with the negative photoresist 326 while the portion of the metal layer 324 to the left of the pit 313 is exposed), an etching process is performed on the negative photoresist 326. The etched substrate is shown in FIG. 17. In a preferred embodiment, an 80/20 O₂/CF₄ etching process is used. Then, as shown in FIG. 18, portions of the negative photoresist 326 are exposed to light 330 via a masking process, as is well known. After being exposed to a developer, the exposed portions of negative photoresist 326 remain while the unexposed portions of the negative photoresist 326 and any underlying metal layer 324 are removed. Finally, as shown in FIG. 20, the optical fiber 312 is installed, and as can be seen, the air gap between the optical fiber 312 and the mirror face (the metal 324 remaining on the 45 degree wall of pit 313) is filled in with negative photoresist 326.

Using the processes described above, the fine geometries of the optical path material can be controlled and the quality of the optical path (the dimensions, alignment, absence of voids, etc.) can be easily and efficiently monitored. The resulting product is of a higher quality than the prior art and requires no polishing to create a quality reflective surface. Additionally, the processes described would be performed during wafer processing, before the engine substrates are separated into individual elements. As a result, hundreds of substrates can be processed simultaneously with this technique, saving both time and money. The prior art of using a liquid underfill can only be performed on one part at a time and all optical elements must be mounted prior to deposition.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A process for forming an a optical device, comprising:
forming a pit in a substrate, said pit having an angled edge;
depositing a reflective layer on the angled edge; and
forming a divergence-limiting material within the pit, thereby covering and protecting the reflective layer and minimizing beam divergence of light traveling therethrough.

2. The process of claim 1, wherein said divergence-limiting material comprises a negative photoresist.

3. The process of claim 1, wherein said divergence-limiting material comprises an epoxy-based negative photoresist.

4. The process of claim 1, wherein said divergence-limiting material comprises SU-8 photoresist.

5. The process of claim 1, wherein said reflective layer comprises a metal that is reflective at a laser wavelength.

6. The process of claim 1, wherein said divergence-limiting material is formed within the pit by spin coating the divergence-limiting material on the substrate and subjecting the spin-coated substrate to an etching process.

7. The process of claim 1, further comprising:
forming a trench in said substrate, wherein said step of forming a divergence-limiting material within the pit also forms a divergence-limiting material with the trench.

8. An optical device, comprising:
a substrate
a pit formed in said substrate, said trench having an angled edge;
a reflective layer deposited on the angled edge; and
a divergence-limiting fill formed within the pit, thereby covering and protecting the reflective layer and minimizing beam divergence of light traveling therethrough.

9. The device of claim 8, wherein said divergence-limiting material comprises a negative photoresist.

10. The device of claim 8, wherein said divergence-limiting material comprises an epoxy-based negative photoresist.

11. The device of claim 8, wherein said divergence-limiting material comprises SU-8 photoresist.

12. The device of claim 8, wherein said reflective layer comprises a metal that is reflective at a laser wavelength.

13. The device of claim 8, wherein said divergence-limiting material is formed within the trench by spin coating the divergence-limiting material on the substrate and subjecting the spin-coated substrate to an etching process.

14. The device of claim 8, further comprising a trench formed in said substrate, said divergence-limiting fill being formed within the trench.
